(19) United States
(12) Patent Application Publication
(10) Pub. No.: US 2025/0071742 A1
(43) Pub. Date: Feb. 27, 2025

(54) METHOD AND APPARATUS FOR CHANNEL INFORMATION FEEDBACK WITH PRIOR INFORMATION IN MOBILE COMMUNICATIONS

(71) Applicant: MEDIATEK INC., Hsinchu City (TW)

(72) Inventors: Chia-Hao YU, Hsinchu City (TW); Tzu-Han CHOU, Hsinchu City (TW); Chin-Kuo JAO, Hsinchu City (TW); Jiann-Ching GUEY, Hsinchu City (TW)

(21) Appl. No.: 18/726,301

(22) PCT Filed: Mar. 21, 2023
(86) PCT No.: PCT/CN2023/082653

§ 371 Date: Jul. 2, 2024

Related U.S. Application Data
(60) Provisional application No. 63/321,852, filed on Mar. 21, 2022.

(51) Int. Cl. H04W 72/0453; H04W 72/044

(52) U.S. Cl. CPC H04W 72/0453; H04W 72/046

(57) ABSTRACT

Various solutions for channel information feedback with prior information with respect to user equipment and network apparatus in mobile communications are described. An apparatus may receive a reference signal transmitted by a network side including at least one network node. The apparatus may obtain at least one selected basis. The apparatus may derive a channel response information observed by a receiving domain of the apparatus according to the reference signal. The apparatus may decompose the channel response information into a preferred domain. The apparatus may determine a simplified linear combination coefficient representation of the channel response information in the preferred domain according to the selected basis. The apparatus May report a compressed channel information to the network side based on the simplified linear combination coefficient representation and the preferred domain.

### CROSS REFERENCE TO RELATED PATENT APPLICATION(S)

The present disclosure claims the priority benefit of U.S. Provisional Patent Application No. 63/321,852, filed on 21 Mar. 2022. The content of aforementioned application is herein incorporated by reference in its entirety.

### TECHNICAL FIELD

The present disclosure is generally related to mobile communications and, more particularly, to channel information feedback with prior information with respect to user equipment (UE) and network apparatus in mobile communications.

### BACKGROUND

Unless otherwise indicated herein, approaches described in this section are not prior art to the claims listed below and are not admitted as prior art by inclusion in this section.

Channel State Information Reference Signal (CSI-RS) is a reference signal (RS) that is used in the downlink (DL) direction in 5G NR, for the purpose of channel sounding and used to measure the characteristics of a radio channel so that it can use correct modulation, code rate, precoder, beam forming, etc. UEs will use these reference signals to measure the quality of the DL channel and report this in the uplink (UL) through the CSI reports. The network node sends CSI-RSs for measuring channel status information such as CSI-Reference Signal Receiving Power (RSRP), CSI-Reference Signal Receiving Quality (RSRQ) and CSI-Signal to Interference plus Noise Ratio (SINR) for mobility procedures. Specific instances of CSI-RSs can be configured for time/frequency tracking and mobility measurements. CSI feedback is the way of indicating certain reports by the UE to the network for indicating channel parameters for, e.g., dynamic scheduling purpose. CSI parameters are the quantities related to the state of a channel. The UE reports CSI parameters to the network node (e.g., gNB) as feedback. The CSI feedback includes several parameters, such as the Channel Quality Indicator (CQI), the Precoding Matrix Indicator (PMI) with different codebook sets and the Rank Indicator (RI). The CSI feedback may also include parameters for indicating a CSI-RS resource (or CSI-RS resource set) based on which the CQI, PMI and RI are derived and reported. The UE uses the CSI-RS to measure the CSI feedback. Upon receiving the CSI parameters, the network node can schedule downlink data transmissions (e.g., modulation scheme, code rate, number of transmission layers and MIMO precoding) accordingly.

In current NR CSI framework, the UE feeds back the UE preferred precoders for CSI feedback. Current CSI report considers a single transmission/reception point (TRP)-UE signal channel. Each UE reports a preferred precoder observed by the UE. The reported precoder may not reflect real channel status and does not consider the interference from transmissions for other UEs. This may be suitable for Single-User Multiple-Input Multiple-Output (SU-MIMO) scenarios where inter-user interference is not a major concern. However, this is not a preferred solution for Multiple-User Multiple-Input Multiple-Output (MU-MIMO) scenarios. The network node cannot determine proper precoders and thus is not able to manage the interferences among multiple UEs. Although the network node may perform some processes to make the signals more orthogonal among different UEs. But such processes may cause signal power loss and may degrade the signal performance.

Accordingly, how to feedback real/proper channel information for channel and interference management becomes an important issue in the newly developed wireless communication network. Therefore, there is a need to provide proper schemes to perform CSI measurement and reporting.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to channel information feedback with prior information with respect to user equipment and network apparatus in mobile communications.

In one aspect, a method may involve an apparatus receiving a reference signal transmitted by a network side including at least one network node. The method may also involve the apparatus obtaining at least one selected basis. The method may further involve the apparatus deriving a channel response information observed by a receiving domain of the apparatus according to the reference signal. The method may further involve the apparatus decomposing the channel response information into a preferred domain. The method may further involve the apparatus determining a linear combination coefficient representation of the channel response information in the preferred domain according to the selected basis. The method may further involve the apparatus reporting a compressed channel information to the network side based on the linear combination coefficient representation and the preferred domain.

In one aspect, an apparatus may comprise a transceiver which, during operation, wirelessly communicates with at least one network node of a network side. The apparatus may also comprise a processor communicatively coupled to the transceiver. The processor, during operation, may perform operations comprising receiving, via the transceiver, a reference signal from the network side. The processor may also perform operations comprising obtaining at least one selected basis. The processor may further perform operations comprising deriving a channel response information observed by a receiving domain of the apparatus according to the reference signal. The processor may further perform operations comprising decomposing the channel response information into a preferred domain. The processor may further perform operations comprising determining a linear combination coefficient representation of the channel response information in the preferred domain according to the selected basis. The processor may further perform operations comprising reporting, via the transceiver, a compressed channel information to the network side based on the linear combination coefficient representation and the preferred domain.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting example scenarios under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a diagram depicting an example scenario under schemes in accordance with implementations of the present disclosure.

FIG. 9 is a block diagram of an example communication system in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to channel information feedback with prior information with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

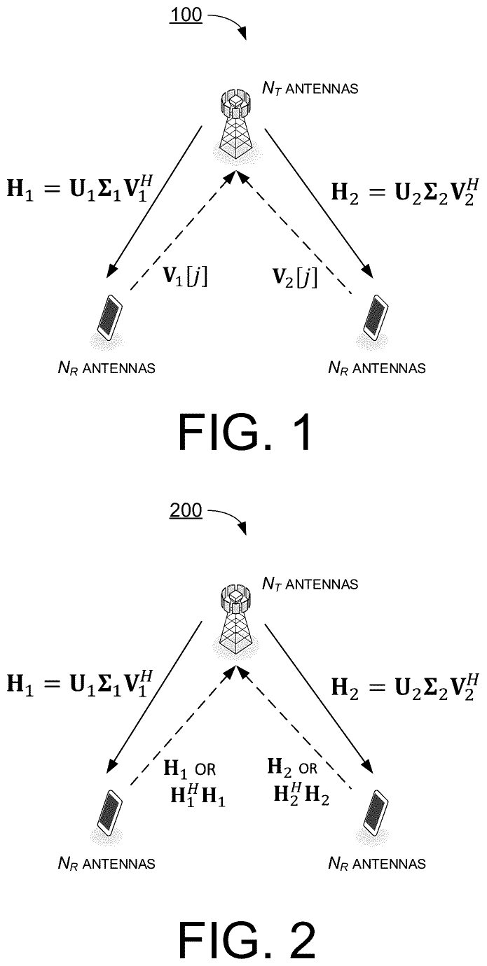

FIG. 1 illustrates an example scenario 100 under schemes in accordance with implementations of the present disclosure. Scenario 100 involves at least one network node and a plurality of UEs, which may be a part of a wireless communication network (e.g., an LTE network, a 5G/NR network, an IoT network or a 6G network). Scenario 100 illustrates the current NR CSI framework. A plurality of UEs (e.g., UE 1 and UE 2) may connect to the network side. The network side may comprise one or more than one network nodes. The network node may transmit the CSI-RS to the UE(s) via N_{T} antennas. Each UE may acquire the channel information between itself and the network node by measuring the CSI-RS via N_{R} antennas and transmit corresponding CSI feedback to the network node. For elaboration purpose, it is assumed a narrowband system where the channel information between a network node and a UE is described by an N_{R}×N_{T} matrix. It will be extended to a wideband system model in the later part of the present disclosure. Let H denote the channel information between the UE and the network node. H can be represented by singular value decomposition H=UΣV^{H}, where U denotes a left eigenvector matrix which may be utilized at receiver side for signal reception, E denotes a diagonal eigenvalue matrix (e.g., representing independent subchannel gains), and V denotes a right eigenvector matrix which may be utilized for precoding at transmitter side. H₁ represents the channel information between the UE 1 and the network node. H₂ represents the channel information between the UE 2 and the network node. In current NR CSI reporting scheme, the UE reports a preferred precoding matrix (e.g., V₁[j] or V₂[j]) to the network node based on a rank assumption where the rank assumption may be reported in a rank indication. However, the reported preferred precoding matrix may not represent the real/whole channel information (e.g., H₁ or H₂) between the network node and the UEs. Without the correct/comprehensive channel information, the network node is not able to well schedule the data transmissions and manage interferences among multiple UEs well.

FIG. 2 illustrates an example scenario 200 under schemes in accordance with implementations of the present disclosure. Scenario 200 involves at least one network node, and one or a plurality of UEs, which may be a part of a wireless communication network (e.g., an LTE network, a 5G/NR network, an IoT network or a 6G network). Scenario 200 illustrates a novel CSI reporting scheme according to proposed schemes of the present disclosure. Instead of reporting the preferred precoding matrix, the UE may be configured to report the whole channel information to the network side. The channel information may comprise H or H^{H}H, where the operator “H” denotes Hermitian transpose, i.e., conjugate transpose of a matrix. The UE 1 may report the channel information (e.g., H₁ or H₁^{H}H₁) between the UE 1 and the network node. The UE 2 may report the channel information (e.g., H₂ or H₂^{H}H₂) between the UE 2 and the network node. In distributed MIMO scenarios, the network side antenna ports jointly serving a UE can be geographically separated. Compared with a traditional scenario where a specific UE is served by one network node, in distributed MIMO scenario, the specific UE may be served by more than one network nodes. In a case that some network nodes are simultaneously serving a few UEs in same resources in distributed MIMO setup, inter-user interference appears. To manage such inter-user interference properly, the knowledge of the channel information between associated network nodes and associated UEs is very beneficial. Essentially, full channel information enables better joint precoder design so that the inter-user interference links are transformed into signal links. Though challenging, coherent Joint Transmission (CJT) scheme is a technique allowing to realize the benefit described above in the distributed MIMO scenario. Accordingly, with comprehensive channel information between network nodes and UEs, the network nodes may be able to well schedule data transmissions and manage interferences among UEs.

In order to enable interference management capability at the network side, the channel information fed back from the UE can be implemented by feeding back the information related to H or H^{H}H. For example, the UE may feedback right eigenvectors and eigenvalues based on Singular Value Decomposition (SVD) of H. Equivalently, the UE may also feedback the eigenvectors and eigenvalues based on Eigen Value Decomposition (EVD) of H^{H}H. The network node can derive the channel information based on the reported information related to H or H^{H}H. Consequently, the network node can acquire the channel information of all UEs. The network node may optimize the precoders (e.g., better orthogonality) to minimize the interferences for MU-MIMO scenarios accordingly.

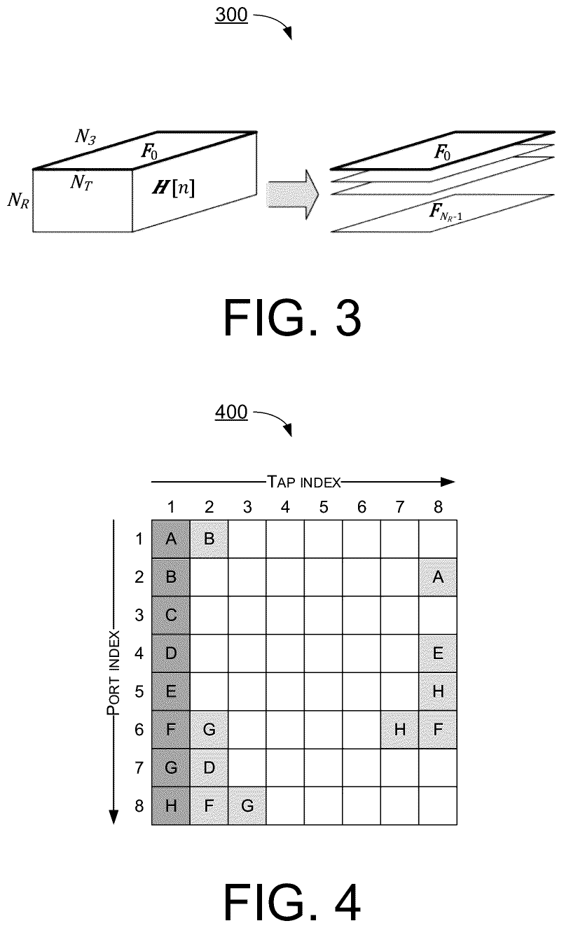

In the following descriptions, the narrowband representation above is extended into the wideband representation. For this purpose, frequency domain consideration will be introduced to the channel information. FIG. 3 illustrates an example scenario 300 under schemes in accordance with implementations of the present disclosure. Scenario 300 involves at least one network node, and one or more UEs, which may be a part of a wireless communication network (e.g., an LTE network, a 5G/NR network, an IoT network or a 6G network). Scenario 300 illustrates an example of channel matrix decomposition method according to proposed schemes of the present disclosure. Both spatial domain (SD) (e.g., antenna ports) and frequency domain (FD) correlation can be exploited for CSI representation. Specifically, a 3-dimensional downlink (DL) channel information may be represented by N_{R}×N_{T}×N₃, where N_{R} denotes antenna ports number at the UE (e.g., 4 antenna ports), N_{T} denotes antenna ports number at the at least one network node (e.g., 32 antenna ports), and N₃ denotes number of frequency sub-bands to be reported. In each sub-band, its spatial channel response may be considered flat. In an extreme case, one sub-band may consist of 1 subcarrier. In general case, one sub-band may consist of more than 1 subcarriers. The 3-dimensional DL channel information can be represented by either {H[n]∈N_{R}×N_{T}, n=0, . . . , N₃−1} or {Fᵣ∈N_{T}×N₃, r=0, . . . , N_{R}−1}. The network node may transmit the reference signal (e.g., CSI-RS) to the UE via N_{T} antennas. The UEs may receive the CSI-RS via N_{R} antennas. The UE may be configured to report CSI feedbacks in N₃ frequency sub-bands or sub-carriers. The UE may determine a MIMO channel matrix by N_{R}×N_{T} for each sub-band. Thus, the cuboid shown in FIG. 3 may represent the channel information observed by the UE. The UE may determine the channel information matrices by {H[n], n=0, . . . , N₃−1} (e.g., 12 H[n]: 32×4 matrices for representing the channel in 12 sub-bands).

The channel information matrices {H[n], n=0, . . . , N₃−1} may represent the full channel information between the UE and the network node. However, the signal overhead for reporting the entire matrices {H[n], n=0, . . . , N₃−1} is huge. Directly reporting {H[n], n=0, . . . , N₃−1} is a burden and inefficient for radio resources. Therefore, the UE may perform some compression processes to reshape/refine the channel information matrices and reduce the signal overhead. Specifically, the UE may derive a channel response information observed by a receiving domain of the UE according to the reference signal. The receiving domain may comprise the antenna ports of the UE. For example, the UE may decompose/reshape the channel information matrices {H[n], n=0, . . . , N₃−1} into a plurality of slices/channel response information (e.g., Fᵣ, r=0 . . . . N_{R}−1) observed by r^{th} receive antenna port of the UE as illustrated in FIG. 3. Each slice/channel response information may be represented by an N_{T}×N₃ matrix. The channel response information {Fᵣ, r=1 . . . . N_{R}−1} is equivalent to the channel information matrices {H[n], n=0, . . . , N₃−1} and represents the channel information observed by the receive antenna ports of the UE.

Then, the UE may decompose/project the channel information matrices {H[n], n=0, . . . , N₃−1} into a two-dimensional domain or a preferred domain. The two-dimensional domain may comprise a first domain related to the network node spatial domain transformation (e.g., the antenna ports of the network node) and a second domain related to a frequency domain transformation. The preferred domain may comprise at least one of a first domain related to the network node spatial domain transformation and a second domain related to a frequency domain transformation. The transformation of the first domain and the second domain is based on Fourier transform. Specifically, the UE may determine a first bases (e.g., discrete Fourier transform (DFT) basis) for the spatial domain (e.g., TX beams of the network node). The UE may determine a second bases (e.g., DFT basis) for the frequency domain (e.g., delay taps). The UE may project the channel response information Fᵣ into the first bases and the second bases. For example, the channel response information Fᵣ may be represented

$${F}_{r} = {W}_{1} {Λ}^{r} {W}_{f}^{H} = [ \begin{matrix}{s}_{1} & ⋯ & {s}_{{N}_{T}}\end{matrix} ] [ \begin{matrix}{λ}_{1 , 1}^{r} & ⋯ & {λ}_{1 , {N}_{3}}^{r} \\ ⋮ & ⋱ & ⋮ \\ {λ}_{{N}_{T} , 1}^{r} & ⋯ & {λ}_{{N}_{T} , {N}_{3}}^{r}\end{matrix} ] [ \begin{matrix}{f}_{1}^{H} \\ ⋮ \\ {f}_{{N}_{3}}^{H}\end{matrix} ] .$$

W₁ denotes the spatial bases, where sᵢ is i^{th} spatial basis (e.g., i^{th} beam). W_{f} denotes the frequency domain bases, where fₘ is m^{th} frequency domain basis (e.g., m^{th} tap). The first bases and the second bases may be pre-stored/pre-defined in the UE and the network node(s). The UE may determine/select the first bases and the second bases according to some parameters (e.g., receive antenna ports).

Based on the above CSI reporting framework, a port selection reporting scheme is introduced to enhance the CSI reporting. In the port selection scheme, P dominant components (e.g., in terms of (SD, FD) pairs) may be selected by the network side, with corresponding RS ports transmitted by using corresponding (SD, FD) bases. One RS port may correspond to one (SD, FD) basis pair. There are two categories of CSI-RS ports may be used for CSI reporting. In a first category of the CSI-RS ports, the CSI-RS transmitted by the network side may comprise a pre-coded CSI-RS. For example, the network side may transmit the CSI-RS with delay pre-compensation in the frequency domain.

FIG. 4 illustrates an example scenario 400 under schemes in accordance with implementations of the present disclosure. Scenario 400 involves at least one network node, and one or more UEs, which may be a part of a wireless communication network (e.g., an LTE network, a 5G/N_{R} network, an IoT network or a 6G network). Scenario 400 illustrates an example of a first category of pre-coded CSI-RS ports (i.e., Category 1-1). The vertical axis represents the port index of the network side in the spatial domain (e.g., 8 ports) observed by the UE. The horizontal axis represents the tap index in the frequency domain (e.g., 8 taps). The CSI-RS transmitted by the network side may be distributed among different ports with different delay taps. With the port selection scheme, the network side may select P dominant bases pairs (e.g., P ports) denoted by {(sᵢ_{₁}, fⱼ_{₁}), ((sᵢ_{₂}, fⱼ_{₂}), . . . , (sᵢ_{ₚ}, fⱼ_{ₚ})} for CSI reporting. Sip denotes the selected SD basis for port P. fⱼ_{ₚ} denotes the selected FD basis for port P. The network side may perform pre-compensation on the selected bases. Since the transmitted RSs may be propagated via different paths and may arrive at the UE with different delays (e.g., delay taps), the network side may pre-compensate the RSs to eliminate those delays. The pre-compensation may be determined based on the channel estimation on UL channels.

Generally, the UE will transmit the sounding reference signal (SRS) in UL. The network side may estimate the channel characteristics between the UE and the network side based on the SRS. Then, the network side may assume that the estimated channel characteristics are similar in DL. Based on such estimation, the network side may acquire most channel characteristics. Therefore, the UE does not need to report all/whole channel information to the network side. The UE may only report a sub-set of channel information required by the network side to reduce CSI reporting burden and signaling overhead. In view of this, the network side may determine the preferred bases pairs and perform the pre-compensations based on the estimated channel characteristics. For the preferred spatial domain bases, the network side may directly transmit the CSI-RS via the selected antenna ports. For the preferred frequency domain bases, the network side may signal to the UE via additional signaling/indication.

As shown in FIG. 4, the (SD, FD) basis positions filled with gray mean that the channel characteristic is significant (e.g., greater than a threshold value). The network side may select those bases as the preferred bases and pre-compensate the delays in the frequency domain so that the desired taps (e.g., A-H) are all shifted to the first tap. With the pre-compensation, the network side may indicate the selected bases via a signaling to the UE (e.g., tap 1 for frequency domain bases). Alternatively, the selected bases may be pre-specified/pre-defined to the UE. Thus, the UE may only calculate/derive the selected bases. For the spatial domain, the network side may use the selected ports for transmitting the CSI-RS on the selected ports. The UE may determine the selected ports by detecting the received CSI-RS. With the port selection scheme, the UE does not need to calculate/derive the non-selected bases in the spatial domain and the frequency domain. Consequently, the burden of CSI measuring and reporting can be reduced for the UE.

The network side may determine a first category of network precoder by N_{T}×P matrix W_{D}[n]=[sᵢ_{₁}fₙⱼ_{₁}*, sᵢ_{₂}fₙⱼ_{₂}* . . . sᵢ_{ₚ}fₙⱼ_{ₚ}] for sub-band n, where fₙⱼ_{ₚ}* denotes the complex conjugate of the n^{th} element of the selected FD basis fⱼ_{ₚ}. With the precoder above, the network side essentially pre-compensates the RS ports so that the frequency domain taps are all lined up at the first one in corresponding spatial domain bases. Thus, the UE only need to derive/calculate one position in the frequency domain bases (e.g., tap 1). The UE may determine not to derive/calculate other positions in the frequency domain bases (e.g., taps 2-8). The burden and complexity for CSI reporting can be reduced.

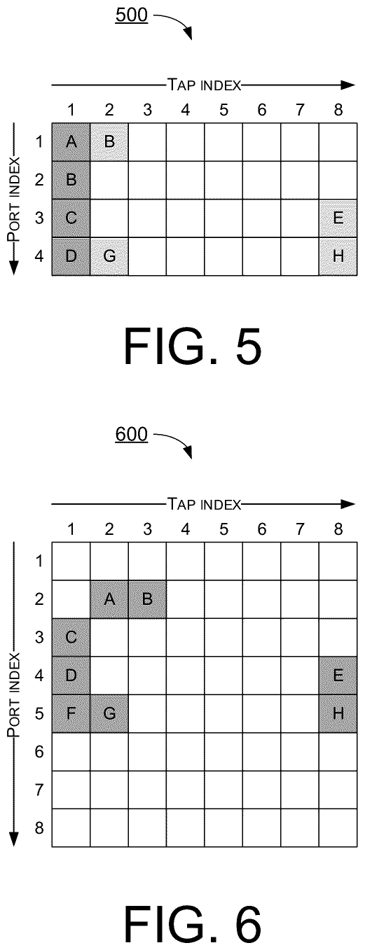

FIG. 5 illustrates an example scenario 500 under schemes in accordance with implementations of the present disclosure. Scenario 500 involves at least one network node, and one or more UEs, which may be a part of a wireless communication network (e.g., an LTE network, a 5G/N_{R} network, an IoT network or a 6G network). Scenario 500 illustrates another example of a first category of pre-coded CSI-RS ports (i.e., Category 1-2). The network side may pre-compensate the RSs to different frequency domain taps. The position of the taps may be signaled to the UE. For example, as shown in FIG. 5, the RSs transmitted by 4 ports (e.g., ports 1-4) are pre-compensated to taps 1, 2 and 8. Thus, the UE only needs to calculate/derive the selected bases on taps 1, 2 and 8. Similarly, the network side may determine the precoder by N_{T}×P matrix W_{D}[n]=[sᵢ_{₁}fₙⱼ_{₁}* sᵢ_{₂}fₙⱼ_{₂}* . . . sᵢ_{ₚ}fₙⱼ_{ₚ}*] for sub-band n, where fₙⱼ_{ₚ}* denotes the difference of complex conjugate of the n^{th} element of the selected FD basis fⱼ_{ₚ} and a reference basis f_{ref}: fₙⱼ_{ₚ}*=fⱼ_{ₚ}−f_{ref}. With the precoder above, the network side essentially pre-compensates the RSS so that the frequency domain taps are all lined up at the ref^{th} SD bases. Thus, the UE only need to derive/calculate few positions in the frequency domain bases (e.g., tap 1, 2 and 8). The UE may determine not to derive/calculate the non-selected positions in the frequency domain bases (e.g., taps 3-7). The burden and complexity for CSI reporting can be reduced.

In some implementations, the UE may further derive/calculate the non-selected bases (e.g., taps 3-7) for considering the imperfect channel reciprocity. In addition to the selected bases, there may be possible that some significant channel characteristics appear on the non-selected bases. Therefore, the UE may search for proper spatial domain and frequency domain bases by itself. In an event that a derived/calculated linear combination coefficient representation is greater than a threshold value, the UE may report the compressed channel information to the network side based on the derived/calculated linear combination coefficient representation.

In a second category of the CSI-RS ports, the CSI-RS is not pre-coded, but the network preferred (SD, FD) basis pairs will be signaled to the UE for directly feeding back corresponding λ_{i,j}^{r} in Fᵣ=W₁Λ^{r}W_{f}^{H} expression. FIG. 6 illustrates an example scenario 600 under schemes in accordance with implementations of the present disclosure. Scenario 600 involves at least one network node, and one or more UEs, which may be a part of a wireless communication network (e.g., an LTE network, a 5G/NR network, an IoT network or a 6G network). Scenario 600 illustrates an example of a second category of the CSI-RS ports (i.e., Category 2). The network side does not pre-compensate the RSs and only indicates the selected bases to the UE. For example, only the frequency domain bases are indicated to the UE (e.g., taps 1, 2, 3 and 8), and the UE may need to search for proper spatial domain basis by itself (e.g., ports 1-8). The UE may decompose the channel response information into all frequency domain bases and spatial domain bases and determine proper bases (e.g., selected and/or significant) for reporting. Further compression for the linear combination coefficient representation may also be applied.

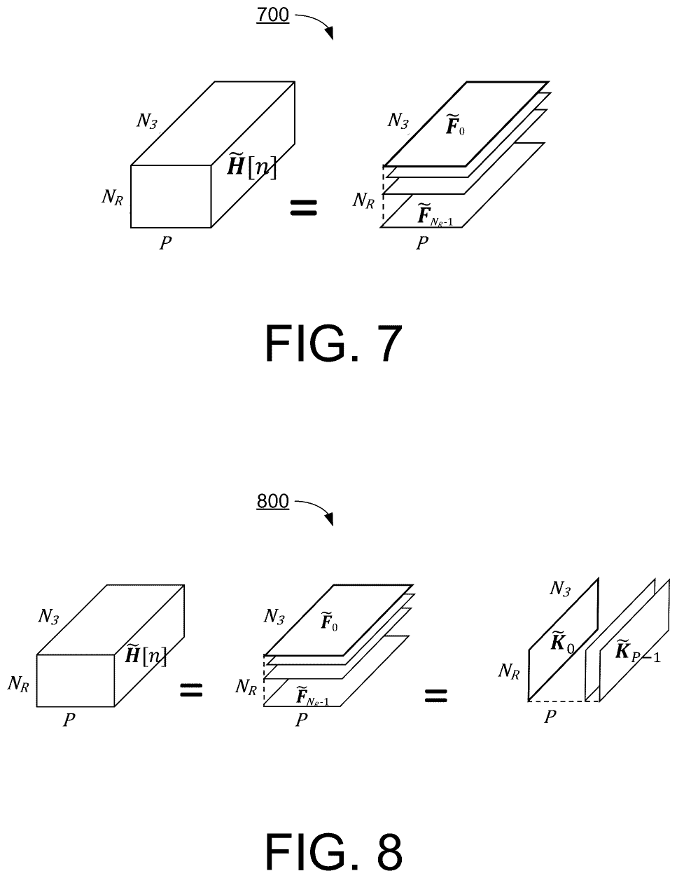

FIG. 7 illustrates an example scenario 700 under schemes in accordance with implementations of the present disclosure. Scenario 700 involves at least one network node, and one or more UEs, which may be a part of a wireless communication network (e.g., an LTE network, a 5G/N_{R} network, an IoT network or a 6G network). Scenario 700 illustrates an example of channel matrix decomposition method according to proposed schemes of the present disclosure. For the first category of network precoder N_{T}×P W_{D}[n], the channel information observed by the UE can be expressed by N_{R}×P pre-coded channel matrices \tilde{H}[n]=H[n]W_{D}[n] in sub-band n=0, . . . . N₃−1.

The UE may decompose/reshape the channel information matrices {H[n]W_{D}[n], n=0, . . . , N₃−1} into a plurality of slices/channel response information (e.g., \tilde{F}ᵣ, r=0 . . . . N_{R}−1) observed by r^{th} receive antenna port of the UE as illustrated in FIG. 7. Each slice/channel response information may be represented by an P×N₃ matrix. The channel response information matrices {\tilde{F}ᵣ, r=0 . . . . N_{R}−1} are equivalent to the channel information matrices {H[n]W_{D}[n], n=0, . . . , N₃−1} and represent the channel information observed by the receive antenna ports of the UE.

Comparing with Fᵣ=W₁Λ^{r}W_{f}^{H}, since \tilde{F}ᵣ has been pre-coded by the network side with selected (SD, FD) pairs W_{D}[n], further decomposing or projecting \tilde{F}ᵣ to SD and FD bases can be simplified. For example, per-RX antenna channel feedback (i.e., channel decomposition) may be determined by

$$= {\sim}^{} {W}_{f}^{H} = [ \begin{matrix} & ⋯ & \\ ⋮ & ⋱ & ⋮ \\ & ⋯ & \end{matrix} ] [ \begin{matrix}{f}_{1}^{H} \\ ⋮ \\ {f}_{{N}_{3}}^{H}\end{matrix} ] .$$

The UE may project per-RX channel into {SD, FD} basis, where FD basis is pre-determined by the network side. If the FD basis used for RS ports are known as prior information (e.g., signaled to UE or pre-defined), the channel information matrices \tilde{H}[n] can be reconstructed by feeding back some simplified linear combination coefficient representation. For example, per receive antenna observed channel coefficient but projected on the network selected FD basis (e.g., fⱼ_{ₚ} for p^{th} port) for each port can be determined by \tilde{Γ}:N_{R}×P. Γ_{r,j}_{ₚ}=\tilde{F}ᵣ^{p}·fⱼ_{ₚ}= [symbol] , where \tilde{F}ᵣ^{p} is p^{th} row of \tilde{F}ᵣ, fⱼ_{ₚ} is the FD basis (e.g., column vector) for p^{th} port, Γ_{r,j}_{ₚ} is (r, p) element of Γ. The UE may report the channel information based on \tilde{Γ}. In one example, the FD basis used for all RS ports are the same to facilitate calculation (e.g., 1^{st} FD basis). In another example, some RS ports may be omitted from feedback if too weak compared to other ports, for example, in terms of magnitude.

The correlation between different receive (RX) antenna ports can be utilized for further compression. For the feedback of \tilde{Γ}:N_{R}×P, the correlation between N_{R} RX antenna ports may be used. For each column in \tilde{Γ} (i.e., same port across different RX antennas), differential feedback may be applied in phase-only, magnitude-only or both phase and magnitude. For example, \tilde{Γ}(1,:) may be fed back in absolute values, while \tilde{Γ}(r,:) for r>1 may be fed back in differential values with respect to \tilde{Γ}(1,:). The fed back values here can be phase-only, magnitude-only or both phase and magnitude.

In addition, for each column (i.e., port) in \tilde{Γ}, denoted by \tilde{Γ}^{p}=[γₚ⁰, γₚ¹, . . . , γₚ^{N}^{_{R}}⁻¹]^{T} for pₜₕ column, it can be further projected into a set of RX spatial domain bases, for example, DFT bases. Then \tilde{Γ}^{p} may be expressed as linear combination coefficients of the set of RX spatial domain bases.

$${\tilde{Γ}}^{p} = [ \begin{matrix}{γ}_{p}^{0} \\ ⋮ \\ {γ}_{p}^{{N}_{R} − 1}\end{matrix} ] = [ \begin{matrix}{a}_{1} & … & {a}_{{N}_{R}}\end{matrix} ] [ \begin{matrix}{c}_{i , m}^{0} \\ ⋮ \\ {c}_{i , m}^{{N}_{R} − 1}\end{matrix} ] ,$$

where [α₁ . . . α_{N}_{_{R}}] denotes the RX spatial domain bases and

$$[ \begin{matrix}{c}_{i , m}^{0} \\ ⋮ \\ {c}_{i , m}^{{N}_{R} − 1}\end{matrix} ]$$

denotes the linear combination coefficient representation after the projection. To further reduce the reporting signaling overhead, only significant elements of the linear combination coefficient representation above may be fed back. In one example, the significant elements may be determined by comparing its magnitude. The ones with stronger magnitude (e.g., greater than a threshold value) are determined as significant ones. The number of feedback element can be one or more than one. The UE may report the compressed channel information to the network side based on the simplified linear combination coefficient representation and the preferred domain.

For the first category of network precoder N_{T}×P W_{D}[n], another CSI reporting scheme may be used. Comparing with Fᵣ=W₁λ^{r}Wⱼ^{H}, since \tilde{F}ᵣ has been pre-coded by the network side with selected (SD, FD) pairs W_{D}[n], further decomposing or projecting \tilde{F}ᵣ to FD bases may still be performed to take into account imperfect channel reciprocity. Since the UL channel estimation performed by the network side may not be correct or identical to DL channels, the UE may derive/project the received channel information to more bases. Projection in FD domain may be either limited to the selected FD bases or to original/additional FD bases. Specifically, except the selected FD bases, the UE may derive/project the received channel information to other/additional FD bases. The UE may determine whether the linear combination coefficients on other bases are significant (e.g., greater than a threshold value) for reporting. The channel matrix \tilde{H}[n] can be reconstructed by feeding back some simplified linear combination coefficient representation. For example, per receive antenna linear combination coefficient representation may be determined by \tilde{Λ}^{r}, where \tilde{F}ᵣ=\tilde{Λ}^{r}Wⱼ^{H}. In one example, some elements may be omitted from feedback if too weak compared to other ports, for example, in terms of magnitude.

The correlation between different RX antenna ports can be utilized for further compression. For the feedback of per receive antenna linear combination coefficient representation \tilde{Λ}″ for r=0 . . . . N_{R}−1, the correlation between \tilde{Λ}^{r} for different r values (e.g., correspond to different RX antennas) may be used. For same elements in \tilde{Λ}″ between different r values (i.e., same {SD, FD} position), differential feedback may be applied in phase-only, magnitude-only or both phase and magnitude. For example, \tilde{Λ}¹ may be fed back in absolute values, while \tilde{Λ}^{r} for r>1 may be fed back in differential values with respect to \tilde{Λ}¹. The fed back values here can be phase-only, magnitude-only or both phase and magnitude.

For same elements (i,m) in \tilde{Λ}^{r} between different r values (i.e., same {SD, FD} position) \tilde{Γ}_{i,m}=[λ_{i,m}⁰, λ_{i,m}¹, . . . , λ_{i,m}^{N}^{_{R}}⁻¹], it may be further projected into a set of RX spatial domain bases, for example, DFT bases. Then \tilde{Γ}_{i,m} may expressed as linear combination coefficients of the set of RX spatial domain bases.

$${\tilde{Γ}}_{i , m} = [ {λ}_{i , m}^{0} , {λ}_{i , m}^{1} , … , 1 {λ}_{i , m}^{{N}_{R} - 1} ] = [ {c}_{i , m}^{0} ⋯ {c}_{i , m}^{{N}_{R} - 1} ] [ \begin{matrix}{a}_{1}^{H} \\ ⋮ \\ {a}_{{N}_{R}}^{H}\end{matrix} ] ,$$

where

$$[ \begin{matrix}{a}_{1}^{H} \\ ⋮ \\ {a}_{{N}_{R}}^{H}\end{matrix} ]$$

denotes the RX spatial domain bases and [c_{i,m}⁰ . . . c_{i,m}^{N}^{_{R}}⁻¹] denotes the linear combination coefficient representation after the projection. To further reduce the reporting signaling overhead, only significant elements of the linear combination coefficient representation above may be fed back. In one example, the significant elements may be determined by comparing its magnitude. The ones with stronger magnitude (e.g., greater than a threshold value) are determined as significant ones. The number of feedback element can be one or more than one. The UE may report the compressed channel information to the network side based on the simplified linear combination coefficient representation and the preferred domain.

For the second category of CSI-RS ports (i.e., Category 2), the CSI-RS is not pre-coded, but the network preferred (SD, FD) basis pairs will be indicated to the UE for directly feeding back corresponding λ_{i,j}^{r} in Fᵣ=W₁Λ^{r}W_{f}^{H} expression. The channel information observed by the UE can be represented by either {H[n] E N_{R}×N_{T}, n=0, . . . , N₃−1} or {Fᵣ∈N_{T}×N₃, r=0, . . . , N_{R}-1} as shown in FIG. 3. Comparing with Fᵣ=W₁Λ^{r}W_{f}^{H}, since network preferred (SD, FD) bases have been provided to the UE, the UE can construct \tilde{H}[n]=H[n]W_{D}[n] similar to the first category of network precoder. The channel information reporting schemes in the first category described above are applicable for the second category as well. Comparing to the first category of CSI-RS ports, since CSI-RS is not pre-coded in the second category of CSI-RS ports, the UE needs to derive/calculate all spatial domain bases and frequency domain bases. However, with the preferred (SD, FD) basis pairs provided by the network side, the UE is able to report the channel information based on the preferred (SD, FD) basis pairs.

FIG. 8 illustrates an example scenario 800 under schemes in accordance with implementations of the present disclosure. Scenario 800 involves at least one network node and one or more than one UEs, which may be a part of a wireless communication network (e.g., an LTE network, a 5G/NR network, an IoT network or a 6G network). Scenario 800 illustrates an example of feeding back the information related to the channel covariance matrix H^{H}H according to proposed schemes of the present disclosure. Similar to channel information H feedback, P dominant components (e.g., in terms of (SD, FD) pairs) may be selected by the network side. The P bases pairs may be denoted by {(sᵢ_{₁}, fⱼ_{₁}), ((sᵢ_{₂}, fⱼ_{₂}), . . . , (sᵢ_{ₚ}, fⱼ_{ₚ})}. The P dominant components can be selected to represent all dominant paths observed from the network side. In view of the above, the channel information observed by the UE can be expressed by H[n]=H[n]W_{D}[n] in sub-band n=0, . . . . N₃−1, where W_{D}[n]=[sᵢ_{₁}fₙⱼ_{₁}* sᵢ_{₂}fₙⱼ_{₂}* . . . sᵢ_{ₚ}fₙⱼ_{ₚ}*]=[W_{D}]. For a particular dominant component p, whose basis expressed by (sₚ, fₚ), the observed channel by the UE can be expressed by a matrix \tilde{K}ₚ:N_{R}×N₃ \tilde{K}ₚ=[H[0]sₚ, H[1]sₚ, . . . , H[N₃−1]sₚ]·fₚ^{H}, where sₚ denotes a spatial precoder for the particular dominant component p, and fₚ^{H} denotes a frequency basis for the particular dominant component p.

Since the frequency domain basis used for RS ports may be provided as prior information (e.g., signaled to the UE or pre-defined), for each RS port (i.e., dominant component), the covariance matrix \tilde{K}ₚ^{H}\tilde{K}ₚ:N₃×N₃ can be reconstructed at the network side if the gain factor after projecting \tilde{K}ₚ to corresponding FD basis (i.e., p^{th} FD basis) is provided to the network side. The gain factor to be fed back can be expressed by fₚ^{H}\tilde{K}ₚ^{H}\tilde{K}ₚfₚ which is equal to |λ_{p,p}^{r}|² (i.e., square of magnitude of a linear combination coefficient representation). Thus, only one value is fed back for each dominant component (i.e., port). The network side is able to reconstruct the channel information based on the reported gain factor. The reporting overhead may be significantly reduced. In another reporting scheme, further decomposing/projecting \tilde{K}ₚ to other/additional FD bases may still be performed to take into account imperfect channel reciprocity. The covariance matrix \tilde{K}ₚ^{H}\tilde{K}ₚ can be reconstructed at the network side if the gain matrix after projecting/decomposing \tilde{K}ₚ to all or a subset of FD bases are provided to the network side. For each dominant component (i.e., port), the gain matrix to be fed back can be expressed by fᵢ^{H}\tilde{K}ₚ^{H}\tilde{K}ₚfᵢ for a predefined set of i. i may comprise the other/additional ports not selected by the network side. The i includes at least p. Thus, the UE may help detect and report the significant channel information that is not determined/estimated by the network side.

### Illustrative Implementations

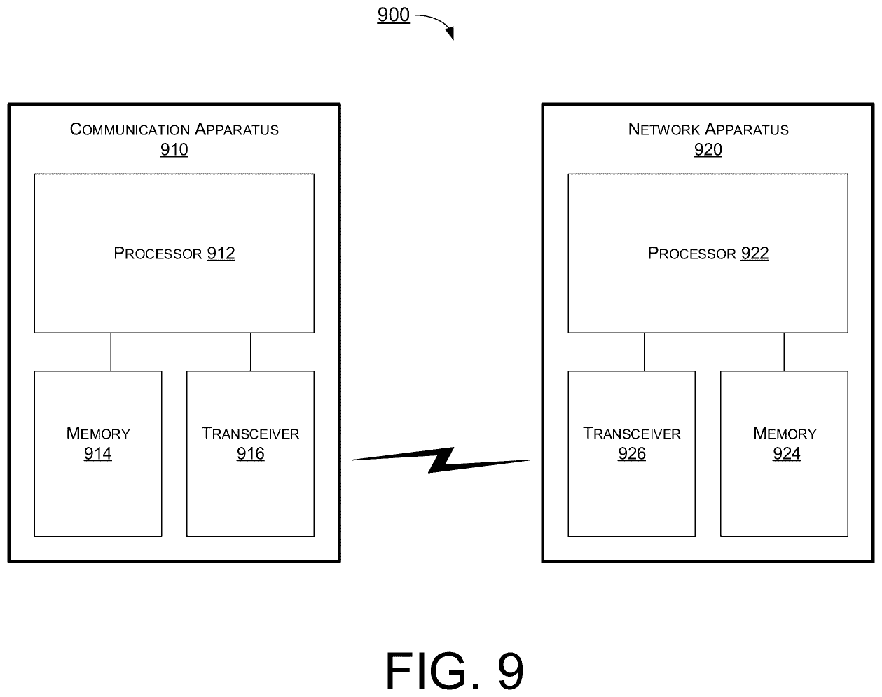

FIG. 9 illustrates an example communication system 900 having an example communication apparatus 910 and an example network apparatus 920 in accordance with an implementation of the present disclosure. Each of communication apparatus 910 and network apparatus 920 may perform various functions to implement schemes, techniques, processes and methods described herein pertaining to channel information feedback with prior information with respect to user equipment and network apparatus in mobile communications, including scenarios/schemes described above as well as process 1000 described below.

Communication apparatus 910 may be a part of an electronic apparatus, which may be a UE such as a portable or mobile apparatus, a wearable apparatus, a wireless communication apparatus or a computing apparatus. For instance, communication apparatus 910 may be implemented in a smartphone, a smartwatch, a personal digital assistant, a digital camera, or a computing equipment such as a tablet computer, a laptop computer or a notebook computer. Communication apparatus 910 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 910 may be implemented in a smart thermostat, a smart fridge, a smart door lock, a wireless speaker or a home control center. Alternatively, communication apparatus 910 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 910 may include at least some of those components shown in FIG. 9 such as a processor 912, for example. Communication apparatus 910 may further include one or more other components not pertinent to the proposed scheme of the present disclosure (e.g., internal power supply, display device and/or user interface device), and, thus, such component(s) of communication apparatus 910 are neither shown in FIG. 9 nor described below in the interest of simplicity and brevity.

Network apparatus 920 may be a part of a network apparatus, which may be a network node such as a satellite, a base station, a small cell, a router or a gateway. For instance, network apparatus 920 may be implemented in an eNodeB in an LTE network, in a gNB in a 5G/NR, IoT, NB-IoT or IIOT network or in a satellite or base station in a 6G network. Alternatively, network apparatus 920 may be implemented in the form of one or more IC chips such as, for example and without limitation, one or more single-core processors, one or more multi-core processors, or one or more RISC or CISC processors. Network apparatus 920 may include at least some of those components shown in FIG. 9 such as a processor 922, for example. Network apparatus 920 may further include one or more other components not pertinent to the proposed scheme of the present disclosure (e.g., internal power supply, display device and/or user interface device), and, thus, such component(s) of network apparatus 920 are neither shown in FIG. 9 nor described below in the interest of simplicity and brevity.

In one aspect, each of processor 912 and processor 922 may be implemented in the form of one or more single-core processors, one or more multi-core processors, or one or more CISC processors. That is, even though a singular term “a processor” is used herein to refer to processor 912 and processor 922, each of processor 912 and processor 922 may include multiple processors in some implementations and a single processor in other implementations in accordance with the present disclosure. In another aspect, each of processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 912 and processor 922 is a special-purpose machine specifically designed, arranged and configured to perform specific tasks including autonomous reliability enhancements in a device (e.g., as represented by communication apparatus 910) and a network (e.g., as represented by network apparatus 920) in accordance with various implementations of the present disclosure.

In some implementations, communication apparatus 910 may also include a transceiver 916 coupled to processor 912 and capable of wirelessly transmitting and receiving data. In some implementations, communication apparatus 910 may further include a memory 914 coupled to processor 912 and capable of being accessed by processor 912 and storing data therein. In some implementations, network apparatus 920 may also include a transceiver 926 coupled to processor 922 and capable of wirelessly transmitting and receiving data. In some implementations, network apparatus 920 may further include a memory 924 coupled to processor 922 and capable of being accessed by processor 922 and storing data therein. Accordingly, communication apparatus 910 and network apparatus 920 may wirelessly communicate with each other via transceiver 916 and transceiver 926, respectively. To aid better understanding, the following description of the operations, functionalities and capabilities of each of communication apparatus 910 and network apparatus 920 is provided in the context of a mobile communication environment in which communication apparatus 910 is implemented in or as a communication apparatus or a UE and network apparatus 920 is implemented in or as a network node of a communication network.

In some implementations, processor 912 may receiving, via transceiver 916, a reference signal from the network side (e.g., network apparatus 920). Processor 912 may obtain at least one selected basis. Processor 912 may derive a channel response information observed by a receiving domain of communication apparatus 910 according to the reference signal. Processor 912 may decompose the channel response information into a preferred domain. Processor 912 may determine a simplified linear combination coefficient representation of the channel response information in the preferred domain according to the selected basis. Processor 912 may report, via transceiver 916, a compressed channel information to the network side based on the simplified linear combination coefficient representation and the preferred domain.

In some implementations, the receiving domain may comprise an antenna port of the apparatus. The preferred domain may comprise at least one of a first domain related to the network side spatial domain transformation and a second domain related to a frequency domain transformation.

In some implementations, the selected basis may comprise at least one of a frequency domain basis and a spatial domain basis.

In some implementations, the reference signal may comprise a pre-coded reference signal determined by the network side (e.g., Category 1-1 or Category 1-2).

In some implementations, the reference signal may be pre-compensated to at least one selected frequency domain basis. In determining the simplified linear combination coefficient representation, processor 912 may determine the simplified linear combination coefficient representation according to the selected frequency domain basis for at least one port transmitted by the network side.

In some implementations, a plurality of reference signals from a plurality of ports of the network side may be pre-compensated to the same selected frequency domain basis (e.g., Category 1-1).

In some implementations, in decomposing the channel response information, processor 912 decompose the channel response information into multiple frequency domain bases. In determining the simplified linear combination coefficient representation, processor 912 may determine the simplified linear combination coefficient representation according to a threshold value for at least one port transmitted by the network side.

In some implementations, the reference signal may comprise no pre-coded reference signal (e.g., Category 2). The preferred domain may comprise a first domain related to the network side spatial domain and a second domain related to a frequency domain transformation. In decomposing the channel response information, processor 912 may decompose the channel response information into all frequency domain bases and spatial domain bases.

In some implementations, processor 912 may determine a gain factor according to at least one selected frequency domain basis for at least one port transmitted by the network side. The gain factor may be derived based on an amplitude of one or more receiving domain after transforming the channel response information into at least one selected frequency domain basis. In reporting the compressed channel information, processor 912 may report the gain factor to the network side.

In some implementations, processor 912 may determine a gain matrix according to all frequency domain bases for at least one port transmitted by the network side. In decomposing the channel response information, processor 912 may decompose the channel response information into the all frequency domain bases. The gain element in the gain matrix may be derived based on an amplitude of one or more receiving domain after transforming the channel response information into one of the all frequency domain bases. In reporting the compressed channel information, processor 912 may report the gain matrix to the network side.

### Illustrative Processes

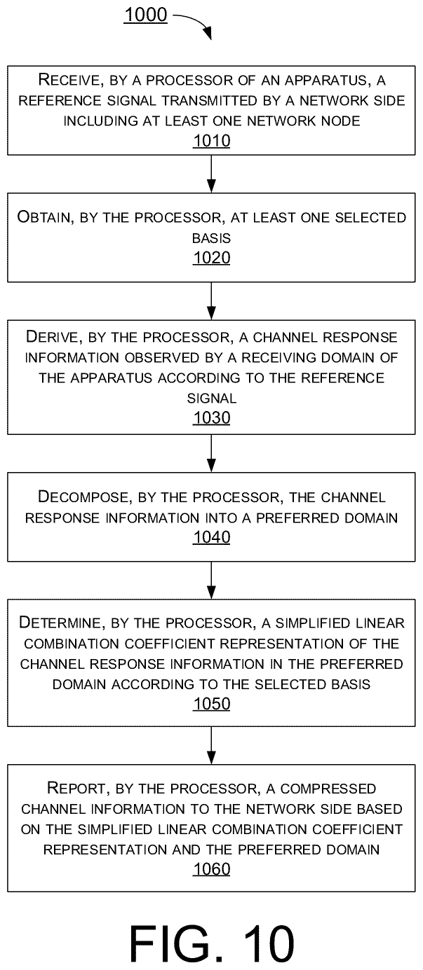

FIG. 10 illustrates an example process 1000 in accordance with an implementation of the present disclosure. Process 1000 may be an example implementation of above scenarios/schemes, whether partially or completely, with respect to channel information feedback with the present disclosure. Process 1000 may represent an aspect of implementation of features of communication apparatus 910. Process 1000 may include one or more operations, actions, or functions as illustrated by one or more of blocks 1010 to 1060. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by communication apparatus 910 or any suitable UE or machine type devices. Solely for illustrative purposes and without limitation, process 1000 is described below in the context of communication apparatus 910. Process 1000 may begin at block 1010.

At 1010, process 1000 may involve processor 912 of communication apparatus 910 receiving a reference signal transmitted by a network side including at least one network nodes. Process 1000 may proceed from 1010 to 1020.

At 1020, process 1000 may involve processor 912 obtaining at least one selected basis. Process 1000 may proceed from 1020 to 1030.

At 1030, process 1000 may involve processor 912 deriving a channel response information observed by a receiving domain of the communication apparatus according to the reference signal. Process 1000 may proceed from 1030 to 1040.

At 1040, process 1000 may involve processor 912 decomposing the channel response information into a preferred domain. Process 1000 may proceed from 1040 to 1050.

At 1050, process 1000 may involve processor 912 determining a simplified linear combination coefficient representation of the channel response information in the preferred domain according to the selected basis. Process 1000 may proceed from 1050 to 1060.

At 1060, process 1000 may involve processor 912 reporting a compressed channel information to the network side based on the simplified linear combination coefficient representation and the preferred domain.

In some implementations, the receiving domain may comprise an antenna port of the communication apparatus. The preferred domain may comprise at least one of a first domain related to the network side spatial domain transformation and a second domain related to a frequency domain transformation.

In some implementations, the selected basis may comprise at least one of a frequency domain basis and a spatial domain basis.

In some implementations, the reference signal may comprise a pre-coded reference signal determined by the network side (e.g., Category 1-1 or Category 1-2).

In some implementations, the reference signal may be pre-compensated to at least one selected frequency domain basis. In determining the simplified linear combination coefficient representation, process 1000 may involve processor 912 determining the simplified linear combination coefficient representation according to the selected frequency domain basis for at least one port transmitted by the network side.

In some implementations, a plurality of reference signals from a plurality of ports of the network side may be pre-compensated to the same selected frequency domain basis (e.g., Category 1-1).

In some implementations, in decomposing the channel response information, process 1000 may involve processor 912 decomposing the channel response information into multiple frequency domain bases. In determining the simplified linear combination coefficient representation, process 1000 may involve processor 912 determining the simplified linear combination coefficient representation according to a threshold value for at least one port transmitted by the network side.

In some implementations, the reference signal may comprise no pre-coded reference signal (e.g., Category 2). The preferred domain may comprise a first domain related to the network side spatial domain and a second domain related to a frequency domain transformation In decomposing the channel response information, process 1000 may involve processor 912 decomposing the channel response information into all frequency domain bases and spatial domain bases.

In some implementations, process 1000 may involve processor 912 determining a gain factor according to at least one selected frequency domain basis for at least one port transmitted by the network side. The gain factor may be derived based on an amplitude of one or more receiving domain after transforming the channel response information into at least one selected frequency domain basis. In reporting the compressed channel information, process 1000 may involve processor 912 reporting the gain factor to the network side.

In some implementations, process 1000 may involve processor 912 determining a gain matrix according to all frequency domain bases for at least one port transmitted by the network side. In decomposing the channel response information, process 1000 may involve processor 912 decomposing the channel response information into the all frequency domain bases. The gain element in the gain matrix may be derived based on an amplitude of one or more receiving domain after transforming the channel response information into one of the all frequency domain bases. In reporting the compressed channel information, process 1000 may involve processor 912 reporting the gain matrix to the network side.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
receiving, by a processor of an apparatus, a reference signal transmitted by a network side including at least one network node;
obtaining, by the processor, at least one selected basis;
deriving, by the processor, a channel response information observed by a receiving domain of the apparatus according to the reference signal;
decomposing, by the processor, the channel response information into a preferred domain;
determining, by the processor, a linear combination coefficient representation of the channel response information in the preferred domain according to the selected basis; and
reporting, by the processor, a compressed channel information to the network side based on the linear combination coefficient representation and the preferred domain.

2. The method of claim 1, wherein the receiving domain comprises an antenna port of the apparatus, and wherein the preferred domain comprises a first domain related to a frequency domain transformation.

3. The method of claim 1, wherein the selected basis comprises at least one frequency domain basis.

4. The method of claim 1, wherein the reference signal comprises a pre-coded reference signal determined by the network side.

5. The method of claim 1, wherein the reference signal is pre-compensated to at least one selected frequency domain basis, and wherein the determining comprises determining the linear combination coefficient representation according to the selected frequency domain basis for at least one port transmitted by the network side.

6. The method of claim 5, wherein a plurality of reference signals from a plurality of ports of the network side are pre-compensated to the same selected frequency domain basis.

7. The method of claim 5, wherein the decomposing comprises decomposing the channel response information into multiple frequency domain bases, and wherein the determining comprises determining the linear combination coefficient representation according to a threshold value for at least one port transmitted by the network side.

8. The method of claim 1, wherein the reference signal comprises no pre-coded reference signal, wherein the preferred domain comprises a first domain related to the network side spatial domain and a second domain related to a frequency domain transformation, and wherein the decomposing comprises decomposing the channel response information into all frequency domain bases and spatial domain bases.

9. The method of claim 1, further comprising:
determining, by the processor, a gain factor according to at least one selected frequency domain basis for at least one port transmitted by the network side,
wherein the reporting comprises reporting the gain factor to the network side,
wherein the gain factor is derived based on an amplitude of one or more receiving domain after transforming the channel response information into at least one selected frequency domain basis.

10. The method of claim 1, further comprising:
determining, by the processor, a gain matrix according to all frequency domain bases for at least one port transmitted by the network side,
wherein the decomposing comprises decomposing the channel response information into the all frequency domain bases,
wherein a gain element in the gain matrix is derived based on an amplitude of one or more receiving domain after transforming the channel response information into one of the all frequency domain bases,
wherein the reporting comprises reporting the gain matrix to the network side.

11. An apparatus, comprising:
a transceiver which, during operation, wirelessly communicates with at least one network node of a network side; and
a processor communicatively coupled to the transceiver such that, during operation, the processor performs operations comprising:
receiving, via the transceiver, a reference signal from the network side;
obtaining at least one selected basis;
deriving a channel response information observed by a receiving domain of the apparatus according to the reference signal;
decomposing the channel response information into a preferred domain;
determining a linear combination coefficient representation of the channel response information in the preferred domain according to the selected basis; and
reporting, via the transceiver, a compressed channel information to the network side based on the linear combination coefficient representation and the preferred domain.

12. The apparatus of claim 11, wherein the receiving domain comprises an antenna port of the apparatus, and wherein the preferred domain comprises a first domain related to a frequency domain transformation.

13. The apparatus of claim 11, wherein the selected basis comprises at least one frequency domain basis.

14. The apparatus of claim 11, wherein the reference signal comprises a pre-coded reference signal determined by the network side.

15. The apparatus of claim 11, wherein the reference signal is pre-compensated to at least one selected frequency domain basis, and wherein, in determining the linear combination coefficient representation, the processor determines the linear combination coefficient representation according to the selected frequency domain basis for at least one port transmitted by the network side.

16. The apparatus of claim 15, wherein a plurality of reference signals from a plurality of ports of the network side are pre-compensated to the same selected frequency domain basis.

17. The apparatus of claim 15, wherein, in decomposing the channel response information, the processor decomposes the channel response information into multiple frequency domain bases, and wherein, in determining the linear combination coefficient representation, the processor determines the linear combination coefficient representation according to a threshold value for at least one port transmitted by the network side.

18. The apparatus of claim 11, wherein the reference signal comprises no pre-coded reference signal, wherein the preferred domain comprises a first domain related to the network side spatial domain and a second domain related to a frequency domain transformation, and wherein, in decomposing the channel response information, the processor decomposes the channel response information into all frequency domain bases and spatial domain bases.

19. The apparatus of claim 11, wherein, during operation, the processor further performs operations comprising:
determining a gain factor according to at least one selected frequency domain basis for at least one port transmitted by the network side,
wherein, in reporting the compressed channel information, the processor reports the gain factor to the network side,
wherein the gain factor is derived based on an amplitude of one or more receiving domain after transforming the channel response information into at least one selected frequency domain basis.

20. The apparatus of claim 11, wherein, during operation, the processor further performs operations comprising:
determining a gain matrix according to all frequency domain bases for at least one port transmitted by the network side,
wherein, in decomposing the channel response information, the processor decomposes the channel response information into the all frequency domain bases,
wherein a gain element in the gain matrix is derived based on an amplitude of one or more receiving domain after transforming the channel response information into one of the all frequency domain bases,
wherein, in reporting the compressed channel information, the processor reports the gain matrix to the network side.
